(19) United States
(12) Patent Application Publication
(10) Pub. No.: US 2004/0050655 A1
(43) Pub. Date: Mar. 18, 2004

(54) Industrial laundry machine

(76) Inventor: Nicolas Baboz, Gresy Sur Aix (FR)

Correspondence Address: CANTOR COLBURN, LLP, 55 GRIFFIN ROAD SOUTH, BLOOMFIELD, CT, 06002

(21) Appl. No.: 10/311,452

(22) PCT Filed: Jun. 15, 2001
(86) PCT No.: PCT/FR01/01881

(30) Foreign Application Priority Data
Jun. 16, 2000 (FR) 00/07738

(51) Int. Cl. B23Q 5/22

(52) U.S. Cl. 198/339.1

(57) ABSTRACT

The invention concerns a machine (4) comprising a vertical mast (15), a carriage (17) mobile along said mast (17), a clamp (18) mounted on said carriage (17), means (20) for driving the carriage (17)/clamp (18) assembly along the mast, means (25, 30) for transferring the extracted articles (1) to a conveyor (5), and means for controlling the movements of the carriage (17)/clamp (18) assembly, including means (37) for detecting whether one or several articles (10) have been gripped. The invention is characterized in that the machine (4) comprises disengaging means (21) acting between said carriage (17) and said carriage driving means (20), said disengaging means (21) providing disengagement between said carriage (17) and said driving means (20) when a stress threshold exerted on the clamp (18) is exceeded, said threshold being less than the one as from which the clamp could be damaged.

Industrial laundry machine, including a vertical mast, a carriage moving along the mast, a clamp mounted on the carriage, means for driving the carriage and clamp assembly along the mast, making it possible to move the assembly between a lower position in which the clamp goes up to and grips articles and an upper position in which the clamp makes it possible to extract one or more of the articles, means for transferring the articles thus extracted to a conveyor to take the articles away, and means for controlling the movements of the carriage and clamp assembly, including means for detecting a gripping of the one or more articles by the clamp, the means for detecting controlling the movement of the carriage and clamp assembly to the upper position when the means for detecting detect that the articles have been gripped, and means for disengaging acting between the carriage and the means for driving the carriage, the means for disengaging providing disengagement between the carriage and the means for driving when a stress threshold exerted on the clamp is exceeded, the threshold being lower than one from which the clamp could be damaged.

This invention concerns an industrial laundry machine for separating articles to be treated, such as sheets or other laundry articles in a clump, as a result of being mixed up together.

An industrial laundry machine includes one or more units for washing laundry and one or more units of drying/ironing/folding of this laundry.

After they are washed, the articles come out all together from the washing unit(s) and must be separated from each other, at least in small bunches so they can then be treated continuously by the drying/ironing/folding units.

Frequently, one or more press unit(s) presses articles between the time they are washed and the time they are subsequently treated, in order to extract a significant part of water that these articles contain. This pressing results in the articles being compacted in the shape of a relatively rigid bale which requires a machine to be used to separate these articles from each other.

There is one such machine, including:

a vertical mast;

a carriage that travels the length of this mast,

a clamp mounted on this carriage;

means of driving the carriage/clamp assembly along the mast, making it possible to move this assembly between a lower position in which the clamp comes up to and grips these articles and an upper position in which the clamp made it possible to extract one or more articles;

means of transferring the extracted articles to a conveyor for taking away these articles, and

control means of the movements of the carriage/clamp assembly, including means for detecting that the clamp is gripping one or more articles; after this detection means has detected that the clamp has gripped some laundry articles, they control the moving of the carriage/clamp assembly to said upper position.

This machine is generally satisfactory but still has the significant disadvantage of causing the clamp to be restricted in its movement, due to the clamp's subsequent deformation, that gradually alters its efficiency. Indeed, the clamp must go into the pile of articles so that it can effectively pick up these articles. However, the surface of the pile of articles can be irregular, and this pile is fairly rigid after it has been pressed. This results in the lowering movement of the carriage/clamp assembly being reversed before it can grip any articles of laundry, which then causes significant stress on the clamp.

Another disadvantage of the existing machines is the fact that the quantity of laundry gripped by the clamp is not always well controlled, and it frequently occurs that the clamp grips a larger quantity of laundry than required for a cycle of gripping/transfer of the articles.

This invention correctly targets these two basic disadvantages.

The machine that it concerns is of the aforementioned type.

According to the invention, this machine includes means of disengagement between said carriage and said carriage driving means. This disengagement means acts between the carriage and the driving means when a stress threshold exerted on clamp is exceeded, which is lower than the one at which the clamp could be damaged.

The invention thus makes it possible to eliminate any risk of such damage, with no need to reinforce the clamp's structure, and therefore without adding weight to this clamp. Such a weight would increase the inertia of the clamp and would be detrimental for the operation of the machine, particularly when the clamp moves which is necessary for the transfer of the articles.

According to a preferred embodiment of the invention,

the driving means includes a geared motor;

the machine includes transmission means, including a notched pulley mounted on the drive shaft of the geared motor, a notched pulley on the drive shaft of the geared motor, a return notched pulley and a notched belt engaged around these pulleys; and

the notched pulley mounted on the shaft of the geared motor includes said disengagement means, which is arranged between this notched pulley and this shaft and is shaped so as to ensure a connection between the pulley and the shaft when they are turning in the same direction and to allow a free rotation of the shaft with respect to the pulley when the pulley simply stops turning or stops turning in the same direction as this shaft.

When the carriage/clamp assembly is lowered or raised, the shaft of the geared motor and the pulley turn in the same direction so that the shaft drives the pulley; when the clamp goes to the laundry, regardless of the surface configuration of the laundry pile, the carriage, the belt and the two pulleys around which this belt is engaged are halted and the shaft can continue to turn freely with respect to the pulley mounted on it, until the laundry has been gripped, at which time the shaft of the geared motor is driven in the reverse direction to become a part of said carriage/pulley assembly near the top.

According to another aspect of the invention,

the clamp is in two parts, that is to say, it includes two independent gripping subassemblies, arranged next to each other and operating independently of each other;

each subassembly is fitted with its own detection means for detecting the presence or absence of articles in this subassembly, and the control means to open and close the jaws of clamp that makes up this subassembly,

the detection means and the control means of these two subassemblies act in such a way that, if the presence of articles is detected in both subassemblies at the same time, the control means of either of the two subassemblies is activated in order to open said gripping jaws of this subassembly to release the article or articles gripped by the same subassembly.

The clamp shaped in this manner makes it possible to much more precisely control the quantity of laundry picked up in each cycle and therefore to regulate the transfer of the laundry to the subsequent treatment units.

For a more complete understanding, the invention is again described below with reference to the attached schematic drawing representing a preferred embodiment of the machine that it concerns as a non-limiting example.

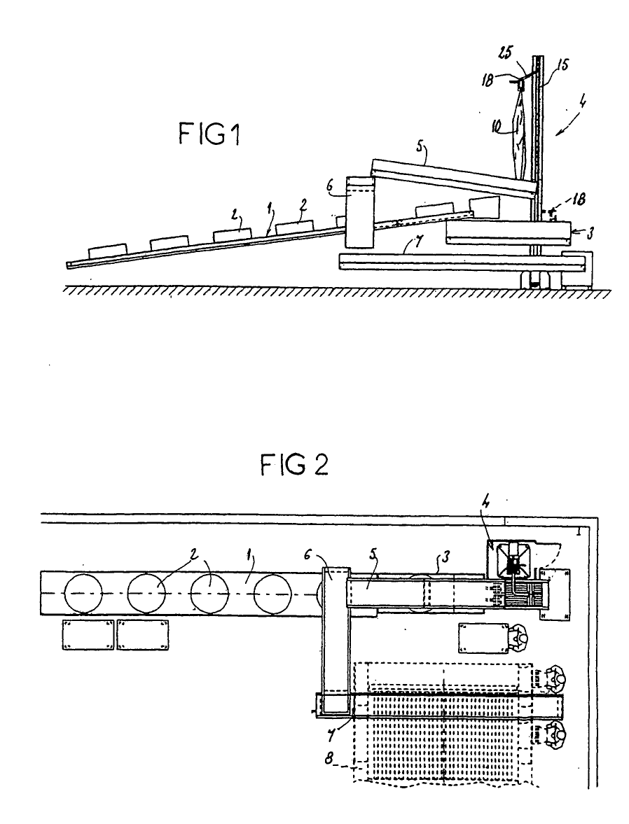

FIG. 1 is an elevation view of an installation including this machine;

FIG. 2 is an overhead view of this installation;

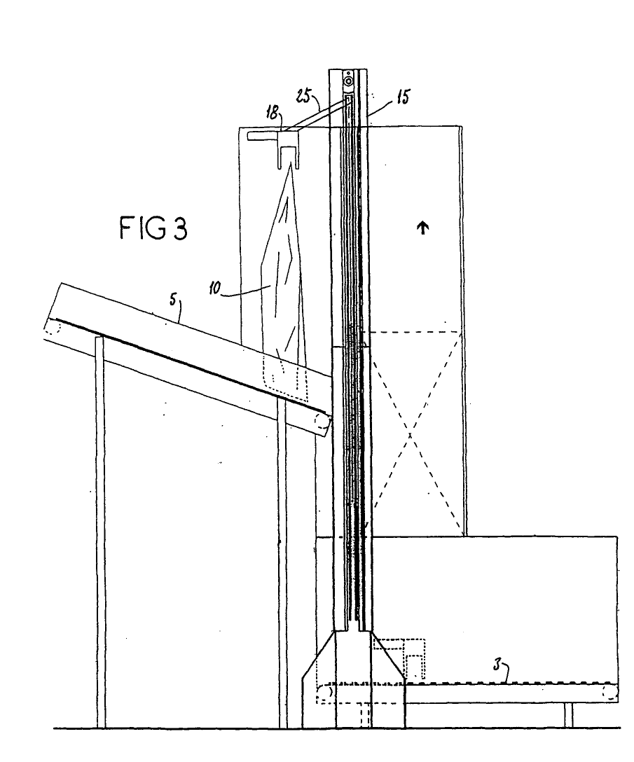

FIG. 3 is a side view of the machine according to the invention, at an enlarged scale, with protective screens that comprise this machine being in place;

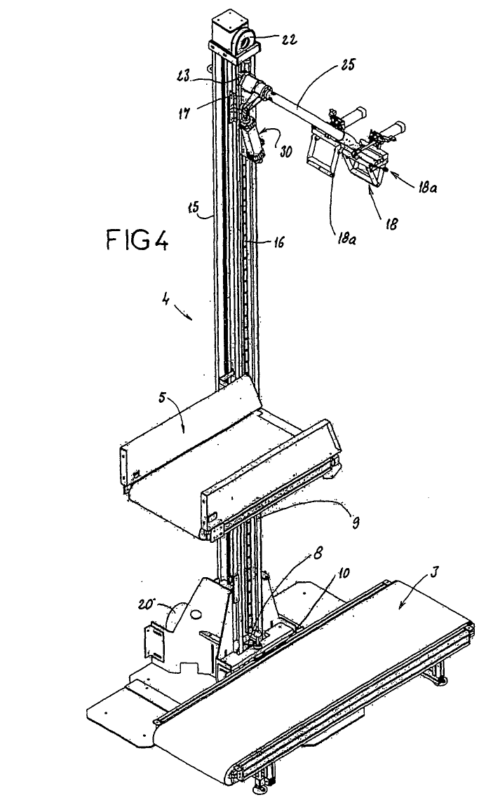

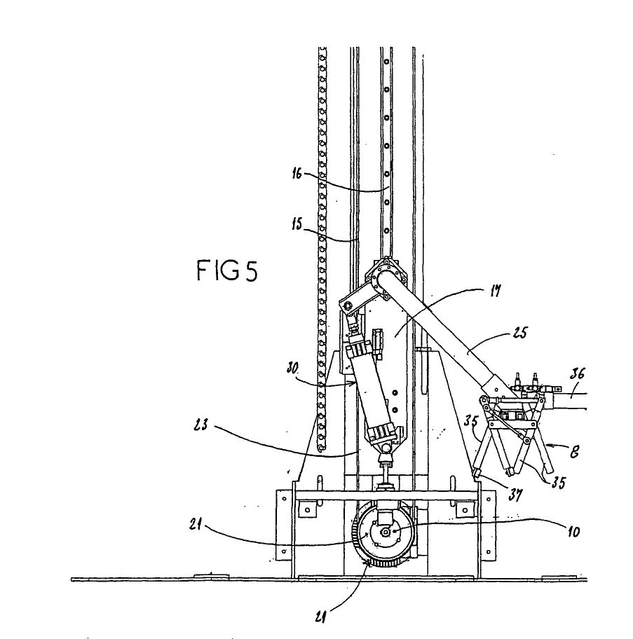

FIG. 4 is a 3-D view, with the screens not represented, and

FIG. 5 is a partial view, from the side and at an enlarged scale.

FIG. 1 and 2 represent a part of the industrial laundry machine in a very simplified and schematic manner. This includes one or more washing and pressing units (not represented) of the laundry, a conveyor 1 moving the piles 2 of pressed laundry, in the form bales that are more or less compact, a conveyor 3 taking the piles 2 near the machine 4 according to the invention, three conveyors 5, 6 and 7 carrying articles of laundry 10 treated by the machine 4, and a subsequent treatment unit 8 of the laundry. In the example represented, the unit 8 is called an “inserting” machine, which makes it possible to spread each article out flat so the article can go into an ironing unit and then into a folding unit.

The machine 4 is for extracting articles 10 from the pile 2 by separating them from each other, minimally into small clumps, so that these articles 10 can then be continuously treated by the subsequent treatment unit or units.

The machine 4 includes:

a vertical mast 15 forming a guide rail 16;

a carriage 17 that can move along this mast 15, in this rail 16;

a clamp 18 in two parts 18a, 18b, mounted on this carriage 17;

a geared motor 20, a notched pulley 21 mounted on the drive shaft of this geared motor 20, a return notched pulley 22 and a notched belt 23 engaged around these pulleys 21, 22 to which the carriage 17 is connected;

a pivoting arm 25 connecting the clamp 18 to the carriage 17 and

control means of the movements of the carriage 17/clamp 18 assembly, including detection means of the gripping of one or more articles 10 by the clamp 18.

The geared motor 20 forms a driving means of the carriage 17/clamp 18 assembly along the mast 15, and the pulleys 21, 22 and the belt 23 forming the transmission means. These various means make it possible to move said assembly between a lower position in which the clamp 18 comes up and grips the articles 10 and an upper position in which this clamp makes it possible to extract one or more articles 10.

The pulley 21 can be disengaged from the shaft that contains it, i.e., the shaft of the geared motor 20 in this case. This pulley 21 can most notably be of the type with moveable balls arranged radially between the shaft and itself, so as to ensure a connection between the pulley and the shaft when they are turning in the same direction and to allow a free rotation of this shaft with respect to this pulley when the pulley simply stops turning or stops turning in the same direction as the shaft.

This pulley 21 thus makes it possible for the clamp 18 to disengage from the geared motor 20 when the clamp comes into contact with the pile of laundry, before the gripping of an article 10 by the clamp 18 has been detected.

The arm 25 is mounted pivoting on the carriage 17 and is activated by an actuator 30 between two positions located on either part of the mast 15. In one of these positions, the clamp 18 is opposite the conveyor 3, so it can operate the gripping of an article 10 and in the other position, the clamp 18 is in a position that is more or less 180° opposed to the first, with the clamp 18 being opposite the conveyor 5 in order to be able to deposit the gripped articles 10 onto the conveyor 5.

Each part of clamp 18a includes two moveable jaws 35 activated by an actuator 36. One of the jaws 35 has a photoelectric cell 37 for detecting the presence of one of more articles 10 between the jaws 35.

This cell 37 is connected to a control assembly, which controls the closing of the jaws 35 when the presence of one or more articles 10 has been detected and that activates the movement of the carriage 17 to the top after the article(s) 10 has been gripped.

The two parts of the clamp 18a are arranged next to each other and operate independently of each other. Said control assembly acts in such a way that, if the presence of articles 10 is detected in both parts of the clamp 18a at the same time, the actuator 36 of one of these parts of the clamp 18a opens the jaws 35 of this part of clamp 18a so to release the article or articles gripped by the same part of clamp 18a.

As shown by the foregoing, the invention provides a machine—with respect to the similar machine of the prior art—that has the advantage of eliminating all excess pressure of the clamp 18 against the pile of laundry 2 and therefore any risk of damaging this jaw 18 by deformation without needing to reinforce the structure of the clamp, and therefore without any detrimental weighting of the clamp. Moreover, the clamp 18 in two parts 18a makes it possible to much more precisely control the quantity of laundry picked up at each cycle, and therefore to regulate the transfer of this laundry to the subsequent treatment units.

1. Industrial laundry machine, including:
a vertical mast (15);
a carriage (17) moving along this mast (17);
a clamp (18) mounted on this carriage (17);
driving means (20) of the carriage (17)/clamp (18) assembly along the mast (15), making it possible to move this assembly between a lower position in which the clamp (18) goes up to and grips the articles (10) and an upper position in which the clamp (18) makes it possible to extract one or more articles (10);
means (25, 30) for transferring the articles (10) thus extracted to a conveyor (5) to take these articles (10) away, and
control means of the movements of the carriage (17)/clamp (18) assembly, including detection means (37) of the gripping of one or more articles (10) by the clamp (18), with these detection means (37) controlling—when they detect that the articles have been gripped—the movement of the carriage (17)/clamp (18) assembly to said upper position;
machine (4) that includes the disengagement means (21) acting between said carriage (17) and said driving means (20) of this carriage, the disengagement means (21) providing disengagement between the carriage (17) and thee driving means (2) when a stress threshold exerted on the clamp (18) is exceeded, said threshold being lower than the one from which the clamp (18) could be damaged.

2. Machine according to claim 1, wherein the
driving means includes a geared motor (20);
the machine (4) includes transmission means, including a notched pulley (21) mounted on the drive shaft of the geared motor (2), a return notched pulley (22) and a notched belt (23) engaged around these pulleys (21, 22); and
the notched pulley (21) mounted on the shaft of the geared motor (20) includes said disengagement means, arranged between the notched pulley (21) and this shaft, and being shaped so as to provide a connection in rotation of this pulley and this shaft when the pulley and this shaft turn in the same direction and to allow a free rotation of the shaft with respect to the pulley when the pulley simply stops turning or stops turning in the same direction as the shaft.

3. Machine in accordance with claim 2, wherein the notched pulley (21) mounted on the shaft of the geared motor (20) is of the type with moveable balls arranged radially between the shaft and the machine, so as to provide a connection in rotation of this pulley and this shaft when the pulley and the shaft turn in the same direction and to allow a free rotation of the shaft with respect to this pulley when the pulley simply stops turning or stops turning in the same direction as the shaft.

4. Machine according to one of the claims 1-3, wherein:
the clamp (18) is in two parts (18a), that is to say, it includes two independent gripping subassemblies, arranged next to each the other and operating independently of each other;
each subassembly (18a) is fitted with its own detection means (37) to detect the presence or absence of articles (1) in this subassembly, and the control means to open and close said gripping jaws (35) comprising this subassembly,
The detection means (37) and the control means of these two subassemblies (18a) act in such a way that the presence of articles (10) is detected in both subassemblies at the same time, the control means of one of the two subassemblies is activated in order to open said gripping jaws (35) of this subassembly (18a) in order to release the article or articles (10) gripped by the subassembly (18a).
